(19) United States
(12) Patent Application Publication
(10) Pub. No.: US 2025/0332552 A1
(43) Pub. Date: Oct. 30, 2025

(54) MIXED MATRIX MEMBRANES

(71) Applicant: Khalifa University of Science and Technology, Abu Dhabi (AE)

(72) Inventors: Linda ZOU, Abu Dhabi (AE); Chao YU, Abu Dhabi (AE)

(21) Appl. No.: 19/185,625

(22) Filed: Apr. 22, 2025

Related U.S. Application Data
(60) Provisional application No. 63/639,880, filed on Apr. 29, 2024.

(51) Int. Cl. B01D 69/14; B01D 61/02; B01D 71/02; B01D 71/08; C02F 1/44; C02F 1/72; C02F 101/20; C02F 101/30

(52) U.S. Cl. CPC B01D 69/14111; B01D 61/027; B01D 69/148; B01D 71/0211; B01D 71/08; C02F 1/442; C02F 1/722; C02F 2101/20; C02F 2101/308; C02F 2305/023

(57) ABSTRACT

A membrane includes a matrix material including chitosan; graphene oxide dispersed in the matrix material; and MXene material dispersed in the matrix material. A method for removing one or more contaminants from a fluid stream includes providing a membrane including a matrix material, graphene oxide dispersed in the matrix material, and MXene material dispersed in the matrix material; and contacting a first fluid stream and the membrane sufficient to form a second fluid stream, wherein the first fluid stream includes one or more contaminants, and wherein the one or more contaminants include at least one of an organic compound and a metal ion.

### CROSS-REFERENCE TO RELATED APPLICATIONS

This application claims the benefit of and priority to U.S. provisional application 63/639,880, titled “2D NANOMATERIALS-ASSISTED CATALYTIC NANOCOMPOSITE MEMBRANE FOR SIMULTANEOUS REMOVAL OF ORGANIC CONTAMINANTS AND HEAVY METALS”, filed Apr. 29, 2024, the contents of which are incorporated by reference herein.

### TECHNICAL FIELD

The subject matter disclosed herein relates to membranes and more particularly to mixed matrix membranes for removal of one or more contaminants from a fluid stream. The present disclosure further includes methods for forming such membranes.

### BACKGROUND

Large amounts of industrial effluent are discharged into the wastewater system. Accordingly, wastewater can include dyes and/or heavy metals (e.g., heavy metal ions). Both dyes and heavy metals can negatively impact the water environment, and human, plant, and animal health, due to strong migration ability, accumulation, and high toxicity. Conventional thin film composite (TFC) membranes have been developed based on polyamide as the active layer and polyethersulfone and cellulose acetate as the porous support layer. However, large amounts of toxic organic solvents are used in the fabrication of TFC membranes, easily causing secondary environmental pollution after disposal of the used organic solvents. Conventional membranes are also prone to low removal efficiencies and high fouling rates. Further, nanocomposite membranes have been developed for separation of certain compounds. However, these conventional nanocomposite membranes require external ultraviolet irradiation input, requiring high overall energy input for operation. Accordingly, developing a membrane exhibiting high removal efficiency for dyes and heavy metal ions with low energy input requirements has remained a challenge.

### SUMMARY

According to one aspect, a membrane includes a matrix material including chitosan; graphene oxide dispersed in the matrix material; and MXene material dispersed in the matrix material.

According to another aspect, a method for removing one or more contaminants from a fluid stream includes providing a membrane including a matrix material, graphene oxide dispersed in the matrix material, and MXene material dispersed in the matrix material; and contacting a first fluid stream and the membrane sufficient to form a second fluid stream, wherein the first fluid stream includes one or more contaminants, and wherein the one or more contaminants include at least one of an organic compound and a metal ion.

According to another aspect, a filtration apparatus includes an inlet configured for introducing a first fluid stream; a nanofiltration membrane in fluid communication with the inlet and configured to at least partially filter the first fluid stream sufficient to form a second fluid stream, wherein the nanofiltration membrane includes a matrix material, graphene oxide dispersed in the matrix material, and a MXene material dispersed in the matrix material; and an outlet in fluid communication with the nanofiltration membrane and configured to receive the second fluid stream.

### BRIEF DESCRIPTION OF THE DRAWINGS

FIG. 1 illustrates a cross section of membrane 100, according to some embodiments.

FIG. 2 illustrates a method for forming a membrane, according to some embodiments.

FIG. 3 illustrates a filtration apparatus for removing one or more contaminants from a fluid stream, according to some embodiments.

FIG. 4 illustrates a method for removing one or more contaminants from a fluid stream, according to some embodiments.

FIG. 5A illustrates a scanning electron microscope (SEM) image of a top view of a neat membrane, according to some embodiments.

FIG. 5B illustrates a scanning electron microscope (SEM) image of a bottom view of a neat membrane, according to some embodiments.

FIG. 5C illustrates a scanning electron microscope (SEM) image of a cross-sectional view of a neat membrane, according to some embodiments.

FIG. 5D illustrates a scanning electron microscope (SEM) image of a top view of a CMG membrane, according to some embodiments.

FIG. 5E illustrates a scanning electron microscope (SEM) image of a bottom view of a CMG membrane, according to some embodiments.

FIG. 5F illustrates a scanning electron microscope (SEM) image of a cross-sectional view of a CMG membrane, according to some embodiments.

FIG. 6A illustrates X-ray photoelectron spectroscopy (XPS) spectra of a neat membrane and a CMG membrane, according to some embodiments.

FIG. 6B illustrates the C 1s narrow scan spectra of a neat membrane, according to some embodiments.

FIG. 6C illustrates the C 1s narrow scan spectra of a CMG membrane, according to some embodiments.

FIG. 6D illustrates the Ti 2p narrow scan spectra of a CMG membrane, according to some embodiments.

FIG. 6E illustrates a water contact angle image of a neat membrane, according to some embodiments.

FIG. 6F illustrates a water contact angle image of a CMG membrane, according to some embodiments.

FIG. 6G illustrates Atomic Force Microscopy (AFM) analysis of a neat membrane, according to some embodiments.

FIG. 6H illustrates Atomic Force Microscopy (AFM) analysis of a CMG membrane, according to some embodiments.

FIG. 7A illustrates porosity and pure water flux of a neat membrane and a CMG membrane, according to some embodiments.

FIG. 7B illustrates the surface charge of a neat membrane, according to some embodiments.

FIG. 7C illustrates the surface charge of a CMG membrane, according to some embodiments.

FIG. 8A illustrates contaminant removal efficiencies of membranes in one pass for 10 ppm of MB and Co²⁺, according to some embodiments.

FIG. 8B illustrates contaminant removal efficiencies of membranes in one pass for 20 ppm of MB and Co²⁺, according to some embodiments.

FIG. 8C illustrates total organic carbon removal efficiencies of membranes using 10 ppm feed solutions, according to some embodiments.

FIG. 8D illustrates contaminant removal efficiencies of membranes in one pass for 10 ppm of MB and Cu²⁺, according to some embodiments.

FIG. 8E illustrates contaminant removal efficiencies of membranes in one pass for 20 ppm of MB and Cu²⁺, according to some embodiments.

FIG. 8F illustrates total organic carbon removal efficiencies of membranes using 20 ppm feed solutions, according to some embodiments.

FIG. 9A illustrates fluorescence emission spectra of using terephthalic acid to detect reactive oxygen species (ROS), using varying amounts of MXene, according to some embodiments.

FIG. 9B illustrates fluorescence emission results of using terephthalic acid to detect reactive oxygen species (ROS), using varying amounts of MXene, according to some embodiments.

FIG. 9C illustrates fluorescence emission spectra of using terephthalic acid to detect reactive oxygen species (ROS), using varying amounts of hydrogen peroxide, according to some embodiments.

FIG. 9D illustrates fluorescence emission results of using terephthalic acid to detect reactive oxygen species (ROS), using varying amounts of hydrogen peroxide, according to some embodiments.

FIG. 10A illustrates flux reduction rates using accelerated fouling analysis with BSA aqueous solution, according to some embodiments.

FIG. 10B illustrates membrane flux using accelerated fouling analysis with BSA aqueous solution, according to some embodiments.

FIG. 10C illustrates flux reduction rates using accelerated fouling analysis with BSA aqueous solution and 20 ppm of methylene blue, Cu²⁺, and Co²⁺, according to some embodiments.

FIG. 10D illustrates membrane flux using accelerated fouling analysis with BSA aqueous solution and 20 ppm of methylene blue, Cu²⁺, and Co²⁺, according to some embodiments.

FIG. 11 illustrates the flux and calculated flux recovery rate (FRR) for neat and CMG membranes, according to some embodiments.

### DETAILED DESCRIPTION

Embodiments of the present disclosure provide membranes (e.g., mixed matrix membranes) and methods for forming membranes. Membranes of the present disclosure can be utilized for various fluid treatment applications, such as removal (e.g., using filtration) of one or more contaminants (e.g., heavy metals and/or dyes) from a water-containing stream. These membranes include a chitosan polymer, graphene oxide, and MXene material(s) for excellent fouling resistance and efficient removal of contaminants. Further, these membranes can generate reactive oxygen species in the presence of hydrogen peroxide, where the reactive oxygen species can oxidize or reduce the contaminants, sufficient for degradation of the contaminants and high removal efficiencies.

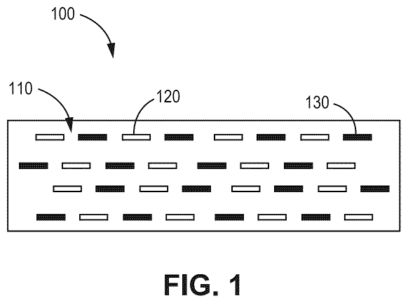

FIG. 1 illustrates a cross section of membrane 100, according to some embodiments. Membrane 100 is a mixed matrix membrane. Mixed matrix membranes include filler dispersed in a matrix material. Accordingly, membrane 100 includes matrix material 110, first filler 120, and second filler 130. As shown in FIG. 1, first filler 120 and second filler 130 are dispersed in matrix material 110. Additionally, or alternatively, first filler 120 and/or second filler 130 can be dispersed on one or more outer surfaces of matrix material 110. In one example, first filler 120 and second filler 130 are substantially homogeneously dispersed in matrix material 110. FIG. 1 is shown for illustrative purposes, and one or more of matrix material 110, first filler 120, and second filler 130 may be scaled smaller or larger. Shapes of first filler 120 and second filler 130 are shown for illustrative purposes, and various shapes and sizes of first filler 120 and second filler 130 are included in the present disclosure. While first filler 120 and second filler 130 are illustrated in FIG. 1 as being physically separated within matrix material 110, in other embodiments at least a portion of first filler 120 can be in contact with at least a portion of second filler 130.

Embodiments of membrane 100 include first filler 120 and second filler 130 dispersed in matrix material 110. Matrix material 110 includes chitosan. Chitosan is a biopolymer having favorable biocompatibility, biodegradability, and non-toxicity. Chitosan includes deacetylated chitin, a linear polysaccharide of deacetylated beta-1,4-D-glucosamine. Chitosan polymers can possess differing degrees of deacetylation. Chitosan of the present disclosure includes at least one of chitosan and a chitosan derivative. Examples of chitosan derivatives include carboxymethyl chitosan (CMCH), hydroxybutyl chitosan (HBC), and N,N, N-trimethyl chitosan (TMC). In one example, chitosan derivatives can be prepared by chemical modification to improve water solubility. In another example, the solubility of chitosan can be increased by introducing a group (e.g., hydrocarbyl, carboxymethyl, acyl, or sulfo group) on the amino or hydroxyl group. In one non-limiting example, chitosan can be dissolved in water, such as under acidic conditions, where other polymers can only be dissolved in toxic organic solvents. The use of toxic organic solvents can be undesirable, at least due to contact with water brought by graphene oxide can cause an unwanted phase change. Chitosan exhibits desirable compatibility with graphene oxide in a water dispersion.

Chitosan can be added to promote hydrophilicity to the membrane product. Improving hydrophilicity can improve the water permeation rate and anti-fouling properties of the membrane in water filtration applications. In one example, since chitosan is a water-soluble polymer, chitosan exhibits excellent compatibility with graphene oxide materials, since these graphene oxide materials can be water-based. During the membrane formation process, chitosan can be added in the form of a chitosan solution. In one example, a chitosan solution is formed by mixing acetic acid (e.g., 15% acetic acid) and chitosan.

First filler 120 and second filler 130 includes a plurality of particles (e.g., nanoparticles) and/or sheets (nanosheets). First filler 120 and second filler 130 can be distinct fillers, such as distinct compounds or materials having distinct chemical compositions. The shape of first filler 120 and second filler 130 can be independently selected from spherical, aspherical, and combinations thereof. Example aspherical shapes include sheet-like, flake-like, plate-like, and rod-like. For example, at least one of first filler 120 and second filler 130 include a plurality of nanosheets. In one example, the nanosheets exhibit a lateral length of greater than 10 nm. In another example, the nanosheets exhibit a lateral length of between 10 nm and 2000 nm. In another example, the nanosheets exhibit a lateral length of between 40 nm and 500 nm. In one example, the nanosheets have a thickness ranging from 0.5 nm to 15 nm. In another example, the nanosheets have a thickness ranging from 1 nm to 10 nm. The concentration of first filler 120 and second filler 130 within matrix material 110 can be tuned according to desired properties, such as contaminant removal efficiency and anti-fouling performance in water treatment.

First filler 120 includes graphene oxide. Graphene oxide can be dispersed in matrix material 110. Graphene oxide is a carbon-containing material including oxygen-containing functional groups. Since graphene oxide can be formed by the oxidation of graphite, graphene oxide is an at least partially oxidized form of graphene. Accordingly, graphene oxide can include both hydrophilic oxygen-containing functional groups and hydrophobic aromatic domains covalently tethered together. Graphene oxide can exhibit varying degrees of oxidation based on the amount of oxygen-containing functional groups. Graphene oxide of the present disclosure can include partially reduced graphene oxide.

Graphene oxide can be synthesized using Hummers' method. Hummers' method can include a chemical process to produce graphene oxide, such as using at least one of sulfuric acid, sodium nitrate, and potassium permanganate. A modified version of the Hummers' method can be utilized. In one example, graphite powder and sodium nitrate can be added to a sulfuric acid solution to form a mixture. After, potassium permanganate can be added to the solution, such as under ice bath conditions. Subsequently, the mixture can be heated, such as heated sufficient for a color change. The mixture can be stirred and transferred to an ice bath. After, deionized water can be added, and the solution can be stirred at room temperature. Then, deionized water can be added to the solution with dropwise addition of hydrogen peroxide. The suspension can be vacuum filtered and washed, and the recovered graphite oxide cake may be washed with hydrochloric acid solution. Accordingly, an exfoliated graphene oxide-containing dispersion can be formed.

Graphene oxide can be in the form of a plurality of graphene oxide nanosheets. Graphene oxide nanosheets are two-dimensional nanomaterials exhibiting high surface area and dispersibility. The graphene oxide nanosheets can be added during the formation process of membrane 100 using exfoliated graphene oxide nanosheets in a dispersion. Graphene oxide of the present disclosure can exhibit tuned lateral lengths and thicknesses based on synthesis conditions. Graphene oxide nanosheets can exhibit a lateral length of greater than 50 nm, greater than 100 nm, greater than 200 nm, greater than 500 nm, greater than 1 μm, or values therebetween. In one example, graphene oxide nanosheets exhibit a lateral length ranging from 50 nm to 5 μm. Graphene oxide nanosheets can have a thickness of less than 10 nm. Graphene oxide nanosheets can have a thickness of less than 4 nm.

Second filler 130 includes one or more MXene materials. The MXene material(s) can be dispersed in matrix material 110. MXenes are a class of two-dimensional material including transition metal carbides, carbonitrides, and nitrides. The MXene can follow the formula: Mₙ₊₁Xₙ, where M is an early transition metal (e.g., Ti, V, Cr, Y, Zr, Nb, Mo, Hf, Ta, or W); X is C or N; and n is 1, 2, or 3. If the MXene has surface terminations, the MXene can follow the formula: Mₙ₊₁XₙTₓ, where M is an early transition metal (e.g., Ti, V, Cr, Y, Zr, Nb, Mo, Hf, Ta, or W); X is C or N; Tₓ refers to surface terminations such as OH, O, F, and/or Cl; and n is 1, 2, or 3. Tₓ can represent a variable number of these surface groups, which can vary depending on the synthesis method and conditions. The metal (M) may be selected to promote desirable purification and degradation of contaminants to the product membrane. The layered structure of the MXene can contribute to desirable properties, such as combining beneficial characteristics of both ceramics and metals. For example, the MXene can feature hydrophilic surfaces, and the MXene can feature adjustable surface properties and excellent mechanical strength. The MXene(s) may be present as exfoliated, two-dimensional nanosheets, and the MXene(s) can be homogenously distributed in the bulk of membrane 100.

The MXene material can exhibit multilayer nanoflakes having a stable hexagonal structure. In one example, the MXene includes a titanium-containing MXene. Titanium-containing MXenes can promote efficient water treatment without producing toxic byproducts. In one example, the layered redox-active crystallite structure of the MXene can contain abundant reaction sites. Further, the large number of surface functional groups can reduce structural symmetry, activating mechanical vibrations. These features can promote efficient activation of hydrogen peroxide sufficient to produce superoxide radicals for efficient filtration and degradation of one or more contaminant species.

The titanium-containing MXene can include a titanium carbide MXene. For example, the MXene may follow the formula: Ti₃C₂Tₓ, where Tₓ is selected from OH, O, F, and/or Cl. In one example, the titanium carbide MXene is stable and provides desirable performance to the membrane for filtration applications. Ti₃C₂Tₓ MXene nanosheets can be formed using in-situ HF etching. A MAX phase material, such as Ti₃AlC₂, can serve as the precursor. The etching process can involve a solution of hydrochloric acid and lithium fluoride to selectively remove the aluminum layer from the MAX phase. Subsequent purification steps include repeated washing and centrifugation to remove impurities. Based on elemental analysis, the titanium carbide MXene can include 7-15 wt. % C, 10-15 wt. % 0, 12-20 wt. % F, 0-5 wt. % Al (or 0.5-5 wt. % Al), and 45-65 wt. % Ti. Alternatively, or in addition to the Ti₃C₂Tₓ MXene, the titanium-containing MXene can include at least one of Ti₂CTₓ and Ti₃CNTₓ.

In one non-limiting example, membrane 100 includes matrix material 110 including chitosan; first filler 120 including graphene oxide nanosheets; and second filler 130 including one or more titanium-containing MXene materials. In one example, membrane 100 includes matrix material 110 including chitosan; first filler 120 including graphene oxide nanosheets; and second filler 130 including Ti₂CTₓ. In another example, membrane 100 includes matrix material 110 including chitosan; first filler 120 including graphene oxide nanosheets; and second filler 130 including Ti₃C₂Tₓ. In another example, membrane 100 includes matrix material 110 including chitosan; first filler 120 including graphene oxide nanosheets; and second filler 130 including Ti₃CNTₓ.

Embodiments of the present disclosure include membrane 100 in the form of a nanofiltration membrane. In one example, compared to reverse-osmosis, nanofiltration membranes for contaminant removal can be desirable due to compact design, operational simplicity, and lower energy consumption. Conventional nanofiltration membranes only separate undesirable substances, but do not degrade the undesirable substances. Nanofiltration membranes of the present disclosure can separate one or more contaminants and degrade the one or more contaminants for high removal efficiency and fouling resistance.

The nanofiltration membrane can exhibit an average pore size greater than 0.01 nm. The nanofiltration membrane can exhibit an average pore size of less than 100 nm. In one example, the nanofiltration membrane exhibits a pore size between 0.1 nm and 20 nm. In another example, the nanofiltration membrane exhibits a pore size between 0.1 nm and 10 nm. Membrane 100 can exhibit a porosity ranging from 1% to 10%. In one example, membrane 100 exhibits a porosity ranging from 1% to 6%. In another example, membrane 100 exhibits a porosity ranging from 2% to 4%. Membrane 100 can exhibit a water contact angle of less than 90°.

Membrane 100 is configured to interact with hydrogen peroxide to form one or more reactive oxygen species (ROS). Reactive oxygen species include at least one chemically reactive radical including oxygen. Examples of reactive oxygen species include at least one of hydroxyl radicals (·OH) and superoxide radicals (·O₂⁻). Reactive oxygen species can promote oxidation or the reduction of one or more contaminants. Electrons can be generated at the same time with the reactive oxygen species, and the electrons can be transferred to heavy metal ion contaminants to reduce the heavy metal ions to zero valent heavy metal. In one non-limiting example, membrane 100 can be used for contaminant treatment and can form reactive oxygen species without the use of ultraviolet irradiation, such as without exposing membrane 100 to ultraviolet irradiation. In one non-limiting example, compared to a metal organic framework and graphene oxide nanocomposite requiring ultraviolet irradiation for filtration, membranes of the present disclosure exhibit excellent removal efficiencies and anti-fouling performance without requiring ultraviolet irradiation exposure.

Chitosan includes abundant hydroxyl and amino active groups. Accordingly, chitosan can provide a size sieving function and can form chemical interactions with contaminants sufficient for electrostatic interactions and/or hydrogen bonding. Since first filler 120 includes graphene oxide and second filler 130 includes one or more MXene materials, the graphene oxide can exhibit support properties for the one or more MXene materials. The abundance of functional groups included in graphene oxide nanosheets can enable the graphene oxide to support the one or more MXene materials—enhancing the stability and efficiency of the one or more MXene materials in generating one or more reactive oxygen species. Graphene oxide can be prepared by oxidation and exfoliation. Accordingly, the graphene oxide can be in the form of nanosheets that are free-standing, flexible sheets that can substantially wrap or support the MXene material(s). This enables a stronger integration of MXene in a chitosan polymer matrix. In one non-limiting example, without graphene oxide present, since MXene can be prepared by chemical etching of oxide material, the morphology of the MXene is less stable in the polymer matrix and can suffer from being leached out.

In one non-limiting example, compared to a chitosan membrane without graphene oxide and MXene material that can suffer from low adsorption capacity, which can be attributed to restricted surface area, membranes of the present disclosure exhibit excellent removal efficiency. In one non-limiting example, compared to an MXene membrane without graphene oxide that can require high-energy input like ultraviolet irradiation, membranes of the present disclosure exhibit excellent removal efficiency without requiring ultraviolet irradiation. Accordingly, the combination of chitosan, graphene oxide (e.g., graphene oxide nanosheets), and one or more MXene materials (e.g., one or more titanium-containing MXene materials) promotes desirable filtration performance while reducing or preventing fouling.

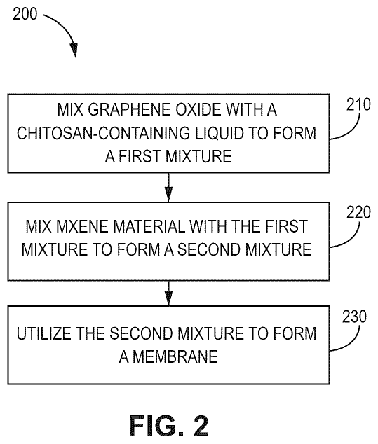

FIG. 2 illustrates a method for forming a membrane, according to some embodiments. Method 200 can be used to form membranes (such as membrane 100) and includes one or more of the following aspects:

Graphene oxide is mixed 210 with a chitosan-containing liquid to form a first mixture. Mixing 210 can include contacting, stirring, heating, and/or placing in close physical proximity. Mixing 210 can be performed at a temperature greater than about 30° C., greater than about 40° C., greater than about 45° C., or values therebetween. Mixing 210 can be performed for a period of time, such as for longer than about 10 minutes, longer than about 30 minutes, longer than 1 hour, or values therebetween. The first mixture can be in the form of a dispersion or a solution.

Graphene oxide utilized in method 200 includes graphene oxide of the present disclosure, such as a plurality of graphene oxide nanosheets (e.g., exfoliated nanosheets). Graphene oxide can be added in the form of a graphene oxide-containing dispersion. In one example, the concentration of graphene oxide in the graphene oxide-containing dispersion ranges from 1 mg/L to 50 mg/L. In one example, the concentration of graphene oxide in the graphene oxide-containing dispersion ranges from 5 mg/L to 15 mg/L. The chitosan-containing liquid includes chitosan. The chitosan-containing liquid can include at least one of acetic acid and water. In one example, the chitosan-containing liquid includes one or more additives. For example, the one or more additives include at least one of polyethylene glycol (PEG) and polyvinylpyrrolidone (PVP). Polyethylene glycol (PEG) and polyvinylpyrrolidone (PVP) can be used as pore forming agents, improving pore interconnectivity and enhancing membrane hydrophilicity. In one non-limiting example, the chitosan-containing liquid includes chitosan, polyethylene glycol, and acetic acid (e.g., 15% acetic acid solution used in formation of the chitosan-containing liquid).

The weight ratio of chitosan to polyethylene glycol in the chitosan-containing liquid can be tuned according to desirable properties of the product membrane, such as mechanical stability and porosity. In one example, the weight ratio of chitosan to polyethylene glycol in the chitosan-containing liquid ranges from about 0.5:1 to 1.5:1. In another example, the weight ratio of chitosan to polyethylene glycol in the chitosan-containing liquid ranges from about 0.75:1 to 1.25:1. In another example, the weight ratio of chitosan to polyethylene glycol in the chitosan-containing liquid is about 1:1.

MXene material is mixed 220 with the first mixture to form a second mixture. Mixing 220 can include contacting, stirring, heating, and/or placing in close physical proximity. Mixing 220 can be performed at a temperature greater than about 30° C., greater than about 40° C., greater than about 45° C., or values therebetween. Mixing 220 can be performed for a period of time, such as for longer than about 10 minutes, longer than about 30 minutes, longer than 1 hour, or values therebetween. The second mixture can be in the form of a dispersion or a solution.

The MXene material includes one or more MXene materials of the present disclosure. In one non-limiting example, the MXene includes a titanium-containing MXene. For example, the titanium-containing MXene can follow the formula: Ti₃C₂Tₓ, where Tₓ is selected from OH, O, F, and/or Cl. Alternatively, or in addition to the Ti₃C₂Tₓ MXene, the titanium-containing MXene can include at least one of Ti₂CTₓ and Ti₃CNTₓ. Prior to mixing 220, the MXene material can be treated using sonication. Prior to mixing 220, the MXene material can be subjected to vacuum filtration with a filter. The MXene material can be added in the form of a MXene dispersion in water.

The second mixture is utilized 230 to form a membrane. The second mixture can be used to form a membrane using phase inversion. For example, phase inversion can include non-solvent induced phase separation (N IPS) or thermally induced phase separation (TIPS). In one non-limiting example, phase inversion includes thermally induced phase separation. Thermally induced phase separation includes using temperature changes sufficient to induce phase separation. The second mixture can be subjected to degassing and can be poured on a surface and heated. In one example, heating is performed at a temperature greater than about 25° C., greater than about 30° C., greater than about 35° C., or values therebetween. H eating can be performed for a period of time, such as for longer than about 10 minutes, longer than about 30 minutes, longer than 1 hour, longer than 6 hours, longer than 10 hours, or values therebetween. After heating, the treated product can be immersed in a neutralizing solution, such as a sodium hydroxide solution. The product membrane can be rinsed with water, such as deionized water.

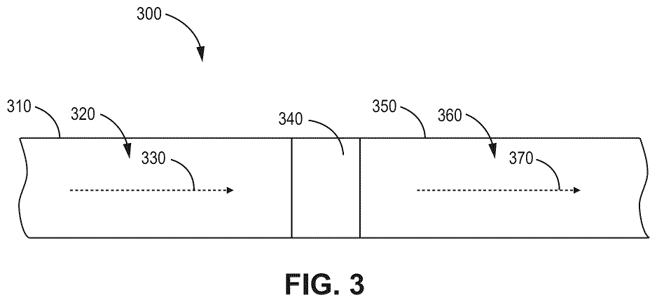

FIG. 3 illustrates a filtration apparatus for removing one or more contaminants from a fluid stream, according to some embodiments. Filtration apparatus 300 includes inlet 310, membrane 340, and outlet 350. Inlet 310 is configured to convey a first fluid stream to membrane 340. Inlet 310 is in fluid communication with membrane 340. Inlet 310 can be directly, fluidically connected to membrane 340. Inlet 310 can define channel 320 for transferring the first fluid stream to membrane 340. In one example, inlet 310 includes a first conduit. In another example, inlet 310 includes a pipe exhibiting a circular cross-section. The first fluid stream can flow along first example flow path 330 toward membrane 340.

The first fluid stream includes a carrier and one or more contaminants. The carrier includes a liquid, gas, vapor, and/or slurry. In one example, the carrier includes water. W ater can be in the form of liquid water and/or water vapor. In one example, the carrier includes water and hydrogen peroxide. In another example, the concentration of hydrogen peroxide in the carrier can be tuned according to contaminant concentrations, such as by using a balanced decomposition reaction equation.

The one or more contaminants can include a heavy metal. The heavy metal can be in the form of a metal ion and/or a metal-containing salt. In one example, the heavy metal includes heavy metal ions. Heavy metal ions can be introduced into water through several sources including the textile industry, coal mining, agriculture activity, and domestic waste. Unfortunately, these heavy metals are common in wastewater and may pose a threat to both humans and animals. The heavy metal can include at least one copper, cobalt, mercury, lead, cadmium, chromium, nickel, and zinc. For example, the heavy metal can include at least one of Cu²⁺ ions, Co²⁺ ions, and metal-containing precursor salts thereof. The heavy metal ions can be present in the first fluid stream at a concentration of greater than 1 mg/L, greater than 5 mg/L, or greater than 10 mg/L. The heavy metal ions can be present in the first fluid stream at a concentration ranging from 1 mg/L to 50 mg/L.

The one or more contaminants can include at least one dye. The dye can include one or more synthetic dyes. Synthetic dyes, such as those used in textile, food, and pharmaceutical industries, contaminate water bodies and can persist in the environment. In one example, the synthetic dye includes methylene blue. M ethylene blue is a synthetic, basic dye, and methylene blue is an organic chloride salt having 3,7-bis(dimethylamino)phenothiazin-5-ium as the counterion. In another example, the synthetic dye includes at least one of methylene blue, acid red, and methyl orange. The one or more synthetic dyes can be present in the first fluid stream at a concentration of greater than 1 mg/L, greater than 5 mg/L, or greater than 10 mg/L. In one non-limiting example, the first fluid stream includes water, methylene blue, and at least one of Cu²⁺ ions and Co²⁺ ions.

Membrane 340 can be selected from a membrane of the present disclosure, such as membrane 100. Membrane 340 can include one or more components, configurations, and/or features of membrane 100. Outlet 350 is configured to receive and/or convey a second fluid stream. Outlet 350 is in fluid communication with membrane 340. Outlet 350 can be directly, fluidically connected to membrane 340. Outlet 350 can define channel 360 for transferring the second fluid stream. In one example, outlet 350 includes a second conduit. In another example, outlet 350 includes a pipe exhibiting a circular cross-section. The second fluid stream can flow along the second example flow path 370. The second fluid stream can flow in a substantially parallel direction to the first fluid stream.

The second fluid stream includes a carrier. The carrier includes a liquid, gas, vapor, and/or slurry. In one example, the carrier includes water. Water can be in the form of liquid water and/or water vapor. While the second fluid stream may include one or more contaminants, the concentration of the one or more contaminants in the second fluid stream is generally less than the concentration of the one or more contaminants in the first fluid stream. The second fluid stream can be recycled and re-introduced to membrane 340 for additional filtration.

The second fluid stream can be in the form of a permeate stream. Permeation through membrane 340 can be at least partially driven by pressure. Accordingly, a pressure difference can be established across membrane 340 to promote the flow of fluid(s) through membrane 340. In one example, a gas can be provided at a pressure sufficient to promote a pressure difference across membrane 340. For example, the gas can include nitrogen gas. Gas can be provided at pressures greater than 2 bar, greater than 4 bar, greater than 6 bar, or greater than 8 bar.

Membrane 340 can exhibit a pure water flux of greater than 30 L m⁻² h⁻¹. Membrane 340 can exhibit a pure water flux of greater than 37 L m⁻² h⁻¹. Membrane 340 can exhibit a pure water flux of greater than 40 L m⁻² h⁻¹. Pure water flux can be calculated using a pressure of about 7 bar. Membrane 340 can exhibit a contaminant rejection rate of greater than 70% in one pass. Contaminant rejection rate can be calculated based on Equation 1:

$$R = ( 1 \frac{{C}_{2}}{{C}_{1}} ) \times 100 \% \qquad ( 1 )$$

where C₂ is the concentration of a contaminant in the second fluid stream, and C₁ is the concentration of the contaminant in the first fluid stream. Membrane 340 can exhibit a contaminant rejection rate of greater than 75% in one pass. Membrane 340 can exhibit a Co²⁺ contaminant rejection rate of greater than 75% in one pass. Membrane 340 can exhibit a Cu²⁺ contaminant rejection rate of greater than 75% in one pass. Membrane 340 can exhibit a methylene blue contaminant rejection rate of greater than 90% in one pass. Membrane 340 can exhibit a methylene blue contaminant rejection rate of greater than 95% in one pass. Rejection rates can be exhibited using a pressure of about 7 bar. Membrane 340 can be cleaned using a liquid including at least one of water and hydrogen peroxide.

Membrane 340 can exhibit a total organic carbon removal efficiency of greater than 80% in one pass. Total organic carbon (TOC) refers to the measurement of the total amount of carbon present in organic compounds within a sample. Membrane 340 can exhibit a total organic carbon removal efficiency of greater than 90% in one pass. Membrane 340 can exhibit a total organic carbon removal efficiency of greater than 94% in one pass. Total organic carbon removal efficiency can be exhibited using a pressure of about 7 bar.

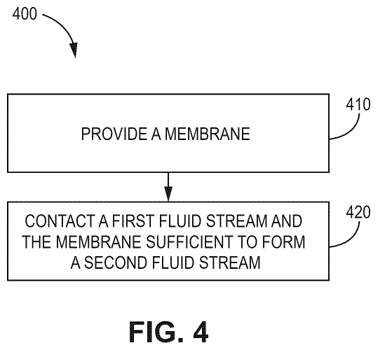

FIG. 4 illustrates a method for removing one or more contaminants from a fluid stream, according to some embodiments. Method 400 includes one or more of the following aspects.

A membrane is provided 410. The membrane includes a membrane of the present disclosure. The membrane includes a matrix material, graphene oxide, and MXene material. In one non-limiting example, the MXene material includes a titanium-containing MXene. For example, the titanium-containing MXene can follow the formula: Ti₃C₂Tₓ, where Tₓ is selected from OH, O, F, and/or Cl. Alternatively, or in addition to the Ti₃C₂Tₓ MXene, the titanium-containing MXene can include at least one of Ti₂CTₓ and Ti₃CNTₓ.

A first fluid stream and the membrane are contacted 420 sufficient to form a second fluid stream. Contacting can include placing the first fluid stream in physical contact with the membrane. By contacting the membrane with the first fluid stream, the first fluid stream can flow across a surface of the membrane and/or pass through at least a portion of the membrane. In one example, contacting includes passing the first fluid stream through at least a portion of the membrane sufficient for the membrane to interact with one or more contaminants present in the first fluid stream. Accordingly, the membrane can remove one or more contaminants from the first fluid stream.

The first fluid stream includes a carrier and one or more contaminants. The carrier includes a liquid, gas, vapor, and/or slurry. In one example, the carrier includes water. W ater can be in the form of liquid water and/or water vapor. In one example, the carrier includes water and hydrogen peroxide. In another example, the concentration of hydrogen peroxide in the carrier can be tuned according to contaminant concentrations, such as by using a balanced decomposition reaction equation.

The one or more contaminants can include a heavy metal. The heavy metal can be in the form of a metal ion and/or a metal-containing salt. In one example, the heavy metal includes heavy metal ions. Heavy metal ions can be introduced into water through several sources including the textile industry, coal mining, agriculture activity, and domestic waste. Unfortunately, these heavy metals are common in wastewater and may pose a threat to both humans and animals. The heavy metal can include at least one copper, cobalt, mercury, lead, cadmium, chromium, nickel, and zinc. For example, the heavy metal can include at least one of Cu²⁺ ions, Co²⁺ ions, and metal-containing precursor salts thereof. The heavy metal ions can be present in the first fluid stream at a concentration of greater than 1 mg/L, greater than 5 mg/L, or greater than 10 mg/L. The heavy metal ions can be present in the first fluid stream at a concentration ranging from 1 mg/L to 50 mg/L.

The one or more contaminants can include at least one dye. The dye can include one or more synthetic dyes. Synthetic dyes, such as those used in textile, food, and pharmaceutical industries, contaminate water bodies and can persist in the environment. In one example, the synthetic dye includes methylene blue. M ethylene blue is a synthetic, basic dye, and methylene blue is an organic chloride salt having 3,7-bis(dimethylamino)phenothiazin-5-ium as the counterion. The one or more synthetic dyes can be present in the first fluid stream at a concentration of greater than 1 mg/L, greater than 5 mg/L, or greater than 10 mg/L. In one non-limiting example, the first fluid stream includes water, methylene blue, and at least one of Cu²⁺ ions and Co²⁺ ions.

The second fluid stream includes a carrier. The carrier includes a liquid, gas, vapor, and/or slurry. In one example, the carrier includes water. Water can be in the form of liquid water and/or water vapor. While the second fluid stream may include one or more contaminants, the concentration of the one or more contaminants in the second fluid stream is generally less than the concentration of the one or more contaminants in the first fluid stream. The second fluid stream can be recycled and re-introduced to membrane 340 for additional filtration.

Membranes of the present disclosure exhibit excellent rejection rates, contaminant degradation performance, and anti-fouling performance. Benefiting from the abundant defect sites of MXene material, the hydrogen peroxide can be broken down catalytically to generate the reactive oxygen species. These reactive oxygen species can oxidize synthetic dyes and can reduce heavy metal ions. The membrane is capable of not only removing synthetic dyes, but the membrane can decompose the synthetic dye. Further, the catalytic activity promoted by the membrane can promote fouling resistance. Accordingly, these membranes can be efficiently used as nanofiltration membranes for removing and/or degrading contaminants commonly found in wastewater, such as textile wastewater.

### Example 1—CMG Membrane

Graphene oxide (GO) nanosheets were synthesized according to a modified Hummer's method. 1.0 g of graphite powder and sodium nitrate were added to 120 mL of sulfuric acid solution and stirred. Then, 6.0 g of potassium permanganate was slowly added under ice bath conditions. Subsequently, the mixed solution was moved to water bath and the temperature was increased to 35° C., and the color of the solution turned to green. The reaction solution was then transferred to ice bath again, followed by adding another 125 mL of deionized (DI) water, which was stirred for 2 hours. The solution color was changed from dark brown to slightly red. After mixing, 250 mL of DI water and hydrogen peroxide (H₂O₂) were added to the above solution until the color became yellow. The suspension was filtered to obtain the graphite oxide followed by rinsing with 200 mL of diluted hydrochloric acid (HCl) (v:v=1:10). Accordingly, the exfoliated graphene oxide dispersion was formed.

The membrane was fabricated by the following steps: 1) 5.0 g of chitosan and 5.0 g of polyethylene glycol were dissolved into 15% acetic acid solution and stirred for 2 hours at 50° C., then the mixture was kept in room temperature until dissolving. 40 mL of the solution as was used as a casting solution for the following steps; 2) 2.0 mL of graphene oxide (GO) dispersion was mixed into the casting solution to serve as the supporting substrate in later mixing the chitosan and MXene, owing to graphene oxide's good flexibility and compatibility with the polymer and MXene.

The MXene particles were firstly treated by continuous sonication, followed by a vacuum filtration with a filter membrane (0.22 μm) at 0.1 MPa, then the well-dispersed MXene particles were resuspended in 3.0 mL DI water and were transferred to a casting solution; 3) The degassed casting solution was poured on the plate laminating machine, then was placed in an oven of 40° C. for 12 hours for a thermal phase inversion process. The fabricated membrane was neutralized by immersing the membrane in 2.0 M sodium hydroxide (NaOH) solution for 2 hours, and the membrane was fetched and washed using DI water several times, and the membrane was stored in DI water. The formed membrane including chitosan, graphene oxide, and a titanium-containing MXene (Ti₃C₂Tₓ) is referred to herein as “CMG”. For comparison, the “neat” membrane was prepared without graphene oxide and MXene. The above steps aimed to thoroughly mix each nanomaterial and polymer solution, to achieve a substantially uniform distribution during the casting process.

A scanning electron microscope was employed to characterize the surface morphology of obtained materials. Fourier-transform infrared spectrometer (FT-IR) was used to analyze the surface chemical compositions. Chemical constitutions analysis of the membrane was also inspected using X-ray photoelectron spectroscopy (XPS). The hydrophilicity of membranes was shown by observing water contact angle values based on contact angle measurement. The concentration of methylene blue (MB) was measured by UV-V is Spectrophotometer (UV-Vis). The inductively coupled plasma-optical emission spectrophotometer (ICP-OES) was used to analyze the concentrations of heavy metal ions. For the electron paramagnetic resonance (EPR) spectra, 5-tert-butoxycarbonyl 5-methyl-1-pyrroline N-oxide (BPMO) as trapping agent and H₂O₂ were added in the trapping agent to measure the generation of radicals. The porosity was measured by a wet-dry method. In detail, the mass of the dry membrane was weighed as m₀. For sufficient contact between the membrane and water, the membrane was then immersed in DI water for 24 h then the mass was recorded as m after fetching. The porosity was calculated by using Equation 2.

$$Porosity = \frac{m - {m}_{0}}{{m}_{0}} \times 100 \% \qquad ( 2 )$$

The filtration experiments of neat membrane and CMG membrane were conducted on a lab-scale dead-end filtration by using a cell with an effective membrane area of 13.8 cm². Different contaminants were used to prepare feed solutions, i.e. MB synthetic dye, and CoCl₂·H₂O and CuCl₂·H₂O heavy metal ions. The feed solutions containing mixed contaminants (MB, CoCl₂·H₂O or MB and CuCl₂·H₂O) passed through the cell under applied pressure by compressed nitrogen gas. The membrane was first placed at the bottom of the cell, and the 50 mL of the feed solution including 10 ppm or 20 ppm contaminants, 30 mmol of H₂O₂ were separately added in the cell.

The permeation experiment was carried out at the applied pressure of 7.0 bar. The purpose of having two different components in the feed (MB and CoCl₂·H₂O or MB and CuCl₂·H₂O) was to evaluate the simultaneous removal ability of the resulting membrane. The permeate solution was collected and tested using the ICP and UV-vis spectrophotometer to determine the concentrations of contaminants. In addition, the sequential permeation tests of 7 filtration cycles were conducted to monitor the accumulative removal results and the permeation samples were collected separately for multiple filtration cycles.

The solvent flux and rejection rate (R) were calculated from Equation 3 and Equation 4, respectively:

$$J = \frac{V}{A t} \qquad ( 3 )$$

$$R = ( 1 \frac{{C}_{p}}{{C}_{f}} ) \times 100 \% \qquad ( 4 )$$

where, V, A and t represent the permeate volume (L), effective filtration area (m²) and filtration time (h), respectively. And the Cₚ and C_{f} represent the concentrations of objectives in the feeding and permeation solution, respectively.

The anti-fouling performances of neat membrane and CMG were evaluated by the accelerated fouling experiments, and the feed solution included 1.0 g/L of bovine serum albumin (BSA) as a contaminant. The first experiment was conducted with the 200 mL feed with BSA only, the second experiment was conducted with the feed with BSA and 20 ppm of MB, CoCl₂·H₂O and CuCl₂·H₂O which presented a wastewater composition. Before each experiment, 30 mmol of H₂O₂ was added in the cell. The experiment was also conducted at applied pressure of 7.0 bar and lasted 8.0 hours. The DI water was first passed the membrane, and the flux was recorded as JW1. After the fouling experiment, the fouled membranes were chemically cleaned with H₂O₂ and DI water, then the flux was measured again as JW2. The flux recovery rate (FRR) was calculated according to Equation 5:

$$FRR = \frac{{J}_{W 2}}{{J}_{W 1}} \times 100 \% \qquad ( 5 )$$

The morphology of GO and MXene were observed by the transmission electron microscopy (TEM) and scanning electron microscopy (SEM). GO sheets had a large and transparent structure containing several graphene layers, meanwhile, some slight folded and wrinkled textures were also observed, indicating their flexibility. The scanning electron microscopy image of MXene showed a relatively loose bonded layered structure with regular interlayer spacing, which was favorable for water transfer.

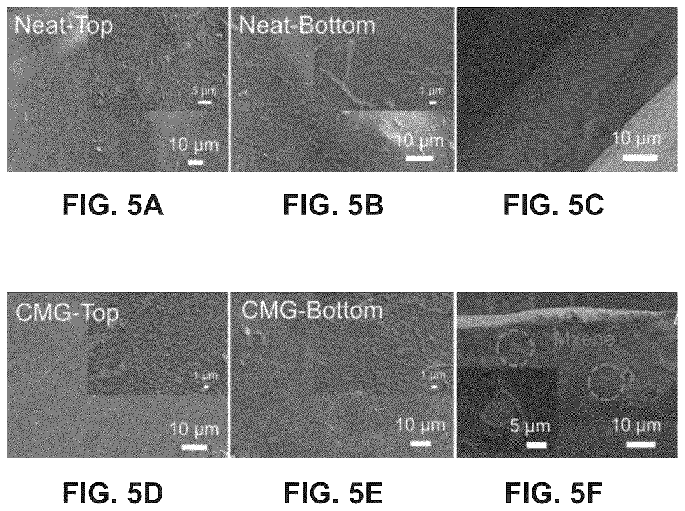

Scanning electron microscope (SEM) imaging was utilized to examine the surface and cross-sectional morphology of different membranes. FIG. 5A illustrates a scanning electron microscope (SEM) image of a top view of a neat membrane, according to some embodiments. FIG. 5B illustrates a scanning electron microscope (SEM) image of a bottom view of a neat membrane, according to some embodiments. FIG. 5C illustrates a scanning electron microscope (SEM) image of a cross-sectional view of a neat membrane, according to some embodiments. For the neat membrane, its top surface showed a smooth and defect free appearance, while its bottom surface had a visible wrinkled pattern.

FIG. 5D illustrates a scanning electron microscope (SEM) image of a top view of a CMG membrane, according to some embodiments. FIG. 5E illustrates a scanning electron microscope (SEM) image of a bottom view of a CMG membrane, according to some embodiments. FIG. 5F illustrates a scanning electron microscope (SEM) image of a cross-sectional view of a CMG membrane, according to some embodiments. In contrast to the neat membrane, the CMG membrane incorporated with GO and MXene displayed a rougher morphology for both top and bottom surfaces compared with that of the neat membrane, with a darker color than the neat membrane. Meanwhile, the cross-sectional SEM images showed that the MXene were visibly well-dispersed in the CMG membrane substrate, which ensured the successful fabrication of CMG membrane, whereas no MXene existed in the substrate of neat membrane matrix.

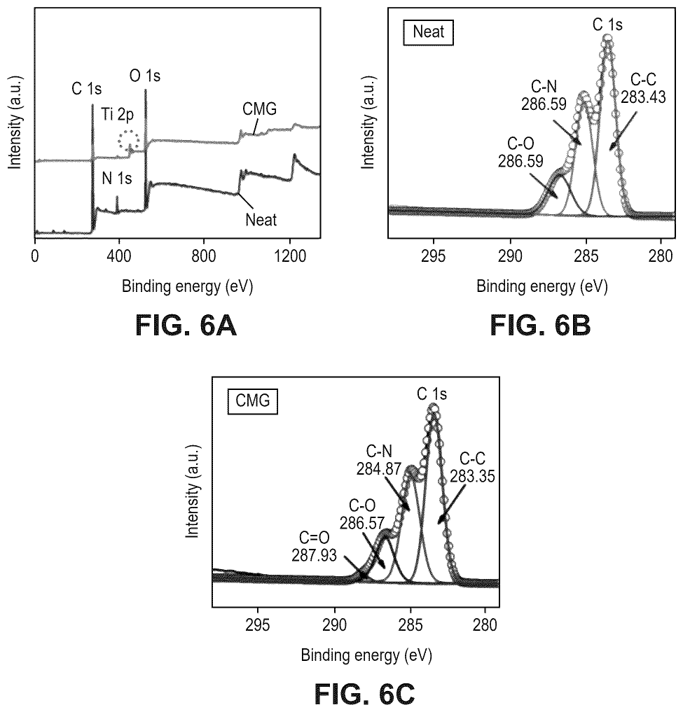

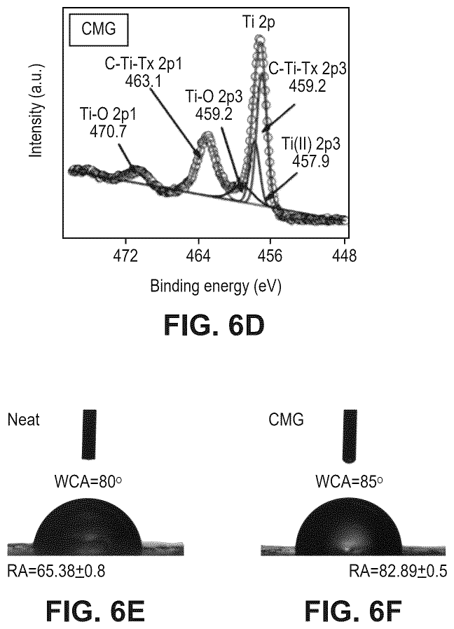

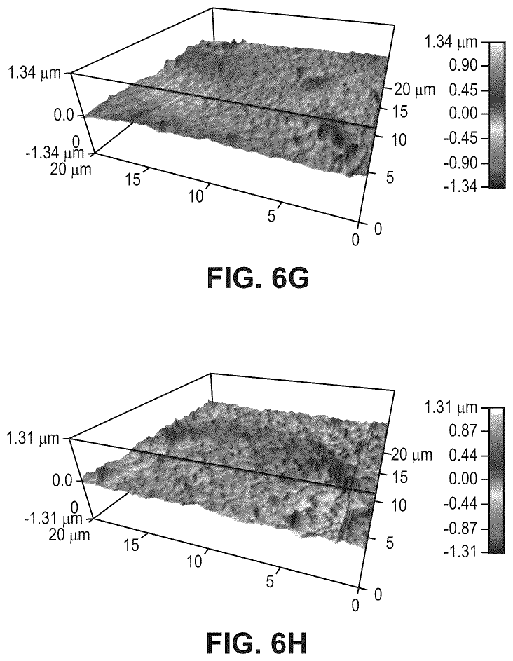

FIG. 6A illustrates X-ray photoelectron spectroscopy (XPS) spectra of a neat membrane and a CMG membrane, according to some embodiments. The high-resolution X-ray photoelectron spectroscopy (XPS) was employed to analyze the chemical composition of neat membrane and CMG membrane—peaks at 284.5 eV, 400 eV and 532.1 eV corresponded to the C, N, and O elements. However, the peak at 456.1 eV representing Ti was distinct in FIG. 6A, showing the presence of MXene in the CMG membrane.

FIG. 6B illustrates the C 1s narrow scan spectra of a neat membrane, according to some embodiments. The XPS spectra of the neat membrane was shown in FIG. 6B, and three peaks of C 1 s at 283.43 eV, 286.59 eV and 286.59 eV could be assigned to the C—C group, C—N group and C—O group, respectively. FIG. 6C illustrates the C 1s narrow scan spectra of a CMG membrane, according to some embodiments. FIG. 6C showed a new peak of C—O group at 287.93 eV at the high resolution XPS spectra of C 1 s of CMG membrane by comparing with neat membrane, which was a characteristic peak of MXene.

FIG. 6D illustrates the Ti 2p narrow scan spectra of a CMG membrane, according to some embodiments. To show the presence of MXene in CMG membrane, it was seen that the Ti 2p peak included Ti (II) 2p₃, C—Ti-Tx 2p₃, Ti—O 2p₃, C—Ti-Tx 2p₁, showing the preparation of CMG nanocomposite membrane.

The X-ray diffraction (XRD) patterns of GO, MXene and CMG were analyzed. For GO, a main peak was located at 11°, which could be indexed as the (001) plane rather than appearing as a broad diffraction peak of graphite at 25° in the (002) plane. By contrast, the MXene sample exhibited a new diffraction peak centered at 7°, corresponding to the (002) crystal plane, indicative of the presence of edge defects. Subsequently, the diffraction peak of CMG at around 10° revealed that the compound diffraction peak of GO and MXene could reflect the membrane performance, which also could be indirectly observed by the decreased lattice constant, indicating chemical crosslinking. Thus, the unique flexible and abundance of functional groups on GO nanosheets enabled them to be a good support of MXene materials, and enhanced the stability and efficiency of MXene in generating ROS.

The surface properties of the prepared CMG membrane were characterized by the water contact angles (WCA) measurement and atomic force microscopy (AFM). FIG. 6E illustrates a water contact angle image of a neat membrane, according to some embodiments. FIG. 6F illustrates a water contact angle image of a CMG membrane, according to some embodiments. A s shown in FIG. 6E and FIG. 6F, similar WCAs with the value of about 80-85° were observed for neat membrane and CMG membrane, which indicated that the additions of MXene and GO does not substantially affect the wettability of membrane surface.

FIG. 6G illustrates Atomic Force Microscopy (AFM) analysis of a neat membrane, according to some embodiments. FIG. 6H illustrates Atomic Force Microscopy (AFM) analysis of a CMG membrane, according to some embodiments. The AFM result showed that the roughness value (Ra) of CMG (82.39±0.5) was higher than neat membrane (65.38±0.8), which can be ascribed to the appearance of the wrinkled pattern observed from SEM result.

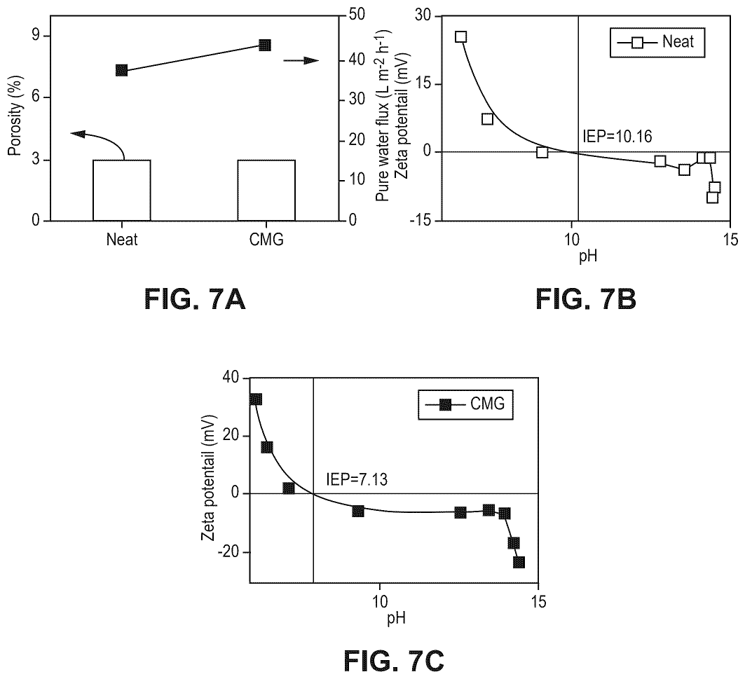

The porosity, pure water flux, and surface charge of both membranes were also analyzed and compared. FIG. 7A illustrates the porosity and pure water flux of a neat membrane and a CMG membrane, according to some embodiments. FIG. 7A showed that CMG membrane had a higher pure water flux (42.8 L m⁻²h⁻¹) than that of neat membrane (36.7 L m⁻²h⁻¹) under similar porosities, showing its superiority in permeation.

FIG. 7B illustrates the surface charge of a neat membrane, according to some embodiments. FIG. 7C illustrates the surface charge of a CMG membrane, according to some embodiments. A s the membrane separation of a contaminant could be affected by the pH conditions in the solution, the charge of neat membrane and CMG and their respective isoelectric point pH ZPC were analyzed. The result showed that the surface of neat membrane exhibited a positive charge at pH equal to the 7.0 with a pH ZPC value of 10.16. The surface charge of the neat membrane changed when the with pH value changed. In contrast to the neat membrane, the pH ZPC value of CMG membrane was decreased to 7.13, demonstrating the suitability of neutral pH condition for the application of CMG membrane. The reason for the pH ZPC value decreasing can be due to the sufficient incorporation of negatively charged MXene and GO with positively charged chitosan membrane, leading to the overall negative charge of CMG membrane surface potential at pH 7.0, whereas the neat chitosan membrane displayed positive charge at the same pH condition.

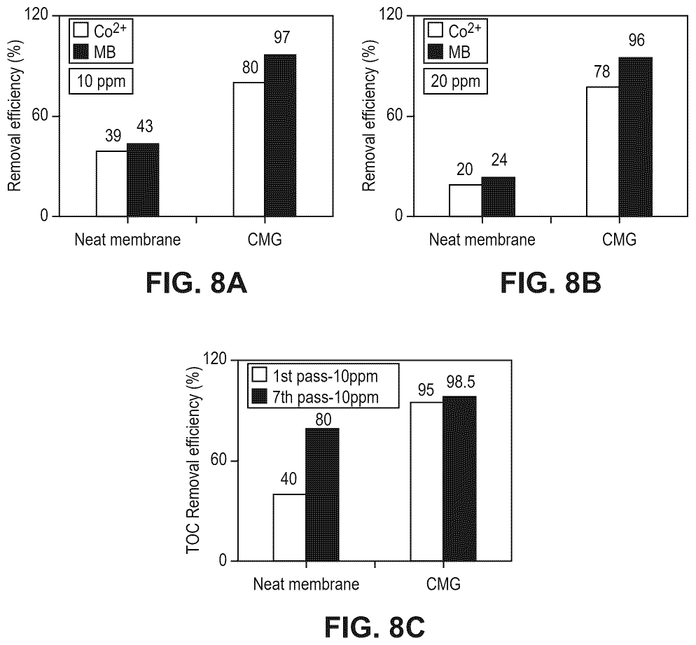

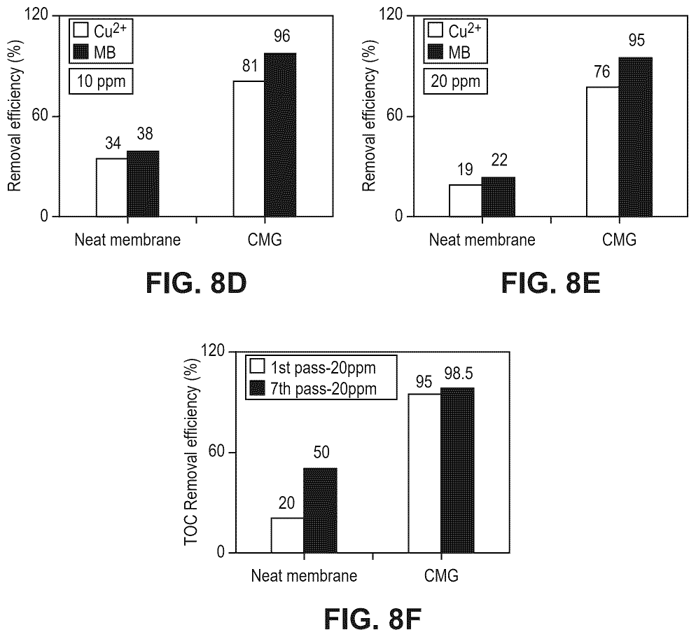

FIG. 8A illustrates contaminant removal efficiencies of membranes in one pass for 10 ppm of MB and Co²⁺, according to some embodiments. FIG. 8B illustrates contaminant removal efficiencies of membranes in one pass for 20 ppm of MB and Co²⁺, according to some embodiments. FIG. 8C illustrates total organic carbon removal efficiencies of membranes using 10 ppm feed solutions, according to some embodiments. FIG. 8D illustrates contaminant removal efficiencies of membranes in one pass for 10 ppm of MB and Cu²⁺, according to some embodiments. FIG. 8E illustrates contaminant removal efficiencies of membranes in one pass for 20 ppm of MB and Cu²⁺, according to some embodiments. FIG. 8F illustrates total organic carbon removal efficiencies of membranes using 20 ppm feed solutions, according to some embodiments.

The removal efficiencies of the membranes for MB and heavy metal ions were analyzed by adapting a static filtration experiment, thus the contaminated solutions were filtered through the membrane at an applied pressure produced by compressed nitrogen gas without hydraulic pump. In this experiment, two groups of feed solutions with different concentrations of contaminants were used, i.e. group 1:10 ppm of MB+Co²⁺ and 10 ppm of MB+Cu²⁺; and group 2:20 ppm of MB+Co²⁺ and 20 ppm of MB+Cu²⁺. As shown in FIG. 8A, the neat membrane achieved 43% and 39% of 10 ppm of MB and Co²⁺ at one pass, respectively. However, it was found that the presence of MXene within the corresponding CMG membrane significantly increased the removal efficiencies, where as high as 97% for MB and 80% for Co²⁺ were achieved in one pass. The contaminants can be adsorbed onto the chitosan/MXene/GO matrix first, and the existence of defect sites on MXene structure catalytically breakdown the H₂O₂ and generate reactive oxygen species such as OH radicals, which can decompose the MB and reduce cobalt ions.

Sequential permeation tests were conducted. The removal efficiencies of CMG membranes for MB and Co²⁺ were separately increased to 99% and 98% after seventh passes, showing their continuous removal capabilities with the permeation times increased, whereas neat membrane only achieved 83% and 69% under the same condition. Such difference in the removal efficiencies curves indicated that multiple mechanisms could work synergistically to enhance the CMG membrane's performance. The similar result was also observed for MB and Cu²⁺, where neat membrane achieved the removal efficacies of 38% and 34% at the first pass, respectively, whereas the CMG membrane achieved as high as 96% and 81% in one pass (FIG. 8D). After seven passes, the CMG membrane has achieved 99% and 96% removal, whereas the removal efficacies of the neat membrane only had a slight increase of 10% at the end of multiple passes owing to its limited capability for degrading contaminant by H₂O₂ alone without reactive oxygen species (ROS).

For the group 2 experiments with 20 ppm of MB+Co²⁺ and 20 ppm of MB+Cu²⁺ as feed solutions, the removal efficiencies by CMG membrane were almost 4 and 3.9 times higher than that of neat membrane in one pass and same folds were kept for the removal efficiencies even at increasing the filtration cycle (FIG. 8B and FIG. 8E). To determine total organic carbon (TOC) removal, experiments were conducted with MB and both heavy metal ions (Co²⁺ and Cu²⁺) at 10 ppm and 20 ppm, respectively. TOC removal rates by CMG membrane (10 ppm MB) reached up to 95% in one pass and achieved 98% after the seventh pass, which were significantly higher than that of neat membrane that had the values of 40% in one pass and 80% after multiple passes (FIG. 8C). The same trends were obtained for the TOC removal of 20 ppm MB and both heavy metal ions (Co²⁺ and Cu²⁺) as feed, where TOC removal rates of CMG membrane achieved remarkable 95% in one pass and finally reached 98.5% after the seventh pass, compared to much lower TOC removal efficiency by neat membrane of only 20% in one pass and 50% after multiple passes (FIG. 8F). The results demonstrated that the catalytic reaction activated by MXene and H₂O₂ played an important role for the continuous removals of contaminants.

Fluorescence spectrometry was employed to indirectly verify the generation of radicals by employing probe molecules. Terephthalic acid (TA) was used to trap the very short-lived radicals and form an intermediate compound, which could emit fluorescence signals under the U V irradiation, and were detected. The amounts of MXene and H₂O₂ were varied in the experiments to investigate the dosages.

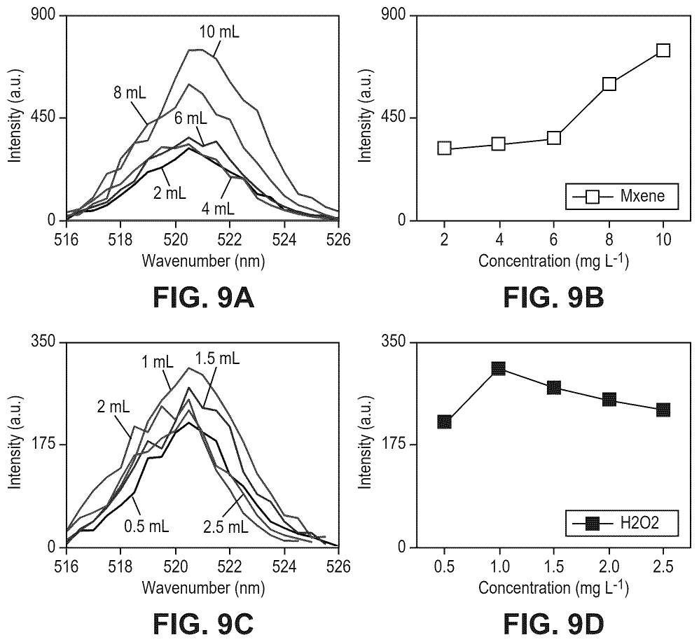

FIG. 9A illustrates fluorescence emission spectra of using terephthalic acid to detect reactive oxygen species (ROS), using varying amounts of MXene, according to some embodiments. FIG. 9B illustrates fluorescence emission results of using terephthalic acid to detect reactive oxygen species (ROS), using varying amounts of MXene, according to some embodiments. As shown in FIG. 9A and FIG. 9B, the peak intensity displayed a sharp increase after MXene concentration was higher than 6.0 mL, which suggested that the higher the MXene quantity, the more the defect sites available for catalytic generation of ROS, and the more radical species generated.

FIG. 9C illustrates fluorescence emission spectra of using terephthalic acid to detect reactive oxygen species (ROS), using varying amounts of hydrogen peroxide, according to some embodiments. FIG. 9D illustrates fluorescence emission results of using terephthalic acid to detect reactive oxygen species (ROS), using varying amounts of hydrogen peroxide, according to some embodiments. Emission peak intensities of different amount of H₂O₂ were compared, where the highest peak intensity was found at λ=520 nm corresponding of adding 1 mL H₂O₂ as the dosage (FIG. 9C and FIG. 9D). This result indicated that the generation of hydroxyl radical was limited by the available defect sites of the MXene, as a result, higher concentration of H₂O₂ became excess. Thus, the H₂O₂ dosage of 1 mL was adopted for this system. The EPR result showed that a DMPO-·O₂⁻ signal with a strong peak appeared after adding H₂O₂ into the MXene solution containing DMPO, showing the reduction of O₂, which was originated from MXene's active site-generated electrons. Therefore, the EPR analysis showed that ·O₂⁻ can be the main species in the contaminant degradation in the presence of MXene.

The catalytic redox removal mechanism of CMG was also investigated, in which the H₂O₂ and MXene were important species for the generation of ROS. It was observed that the removal performance of MB, Cu²⁺ and Co²⁺ decreased when the neat membrane was used, in comparison to that in the CMG. This can be attributed to the occupation of electron-rich centers within defect sites of MXene, which produced plenty of —OH, ·O₂⁻ and ¹O₂ radicals that could effectively oxidize the MB and reduce the Cu²⁺ and Co²⁺ during the permeation process. The reaction process is shown below.

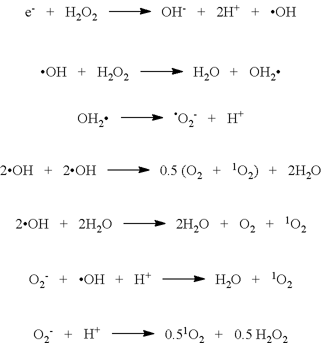

Electrons are generated at the same time with the ROS, and such electrons are transferred to the heavy metals ions to reduce them into zero valent heavy metal and are removed from solution. The reduction process can be represented below.

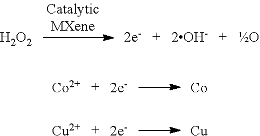

Table 1 shows the comparison of CMG membrane with other membranes. CMG membrane with nano-additives of MXene had relatively high MB removal efficiencies (96%) compared to other nanofiltration membranes. Further, the removal efficiencies of heavy metal ions by CMG membrane also exceeded most of the conventional membranes. Importantly, CMG membrane still maintained a much higher flux than others. This result shows the advantage of abundant defects provided by MXene and rational design of membrane structure successfully promoted the catalytic generation of ROS for high-efficiency removal of harmful dye and heavy metals from wastewater.

TABLE 1
Fluxes and Removal Efficiencies of Various Membranes

Removal Efficiency (%)

| Materials | Flux (L m⁻² h⁻¹) | MB | Co²⁺ | Cu²⁺ |
|---|---|---|---|---|
| starch/CNP | — | 94 | — | — |
| c-CNT@GO | 13.2/Bar | 94.1 | — | — |
| Sb₂O₃/CBO | 18.5/Bar | 90.6 | — | — |
| NF270 | 4.63/Bar | — | — | 74.3 |
| POSS-TiO₂ | 1.58/Bar | — | — | 66 |
| MNAC | 6.21/Bar | — | — | 66 |
| TFNC-1 | ~20.0/Bar | — | 66.5 | — |
| ESNA | 3.33/Bar | — | 72 | 76 |
| Cyanex301 | — | — | 46.85 | — |
| CMG | 6.11/Bar | 96 | 78 | 76 |

Conventional membrane used to treat real wastewater inevitably suffered from fouling caused by organic foulants and bacteria, which severely blocked the membrane pores and thus reduced the permeation flux. The anti-fouling ability of CMG and neat membranes were evaluated in two accelerated fouling experiments: the first experiment was conducted using 1.0 g/L of BSA aqueous solution as feed; BSA and 20 ppm of MB, CoCl₂·H₂O and CuCl₂·H₂O were used as feed solution in the second experiment representing a composition similar to wastewater. The relative flux reduction (J/J0) was calculated and plotted as a function of the permeation time.

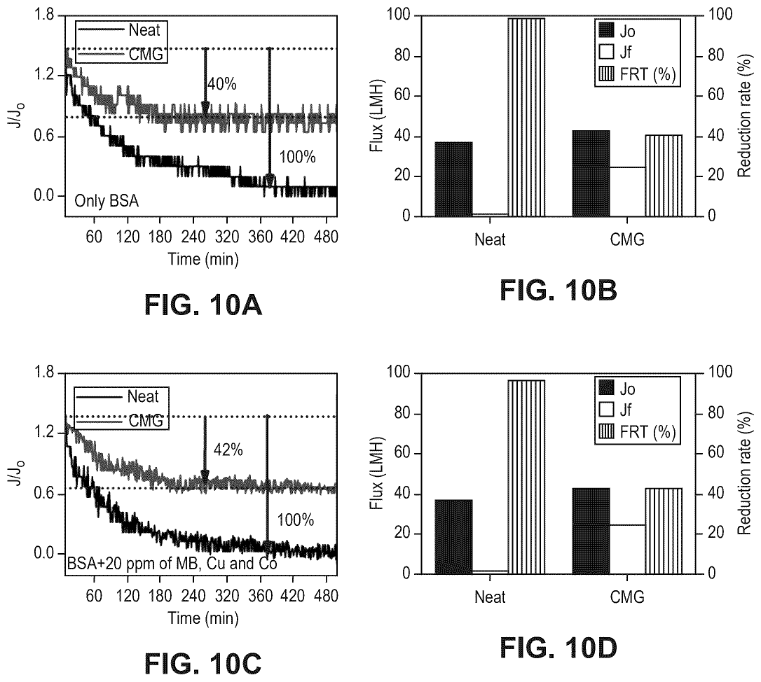

FIG. 10A illustrates flux reduction rates using accelerated fouling analysis with BSA aqueous solution, according to some embodiments. FIG. 10B illustrates membrane flux using accelerated fouling analysis with BSA aqueous solution, according to some embodiments. From FIG. 10A, it could be seen that the J/J0 of the neat membrane had a rapid decrease with increase in the permeation time, which could be ascribed to the accumulated attachment of BSA during the permeation process, leading to the blockage of membrane pores, and showed an continuously J/J0 decline to almost zero (reduction rate of 100%) within the permeation time of 150 min (FIG. 10A and FIG. 10B); on the other hand, although the J/J0 of the CMG membrane initially decreased, it gradually stabilized without further decline, with a total J/J0 decline (reduction rate) of 40% only.

FIG. 10C illustrates flux reduction rates using accelerated fouling analysis with BSA aqueous solution and 20 ppm of methylene blue, Cu²⁺, and Co²⁺, according to some embodiments. FIG. 10D illustrates membrane flux using accelerated fouling analysis with BSA aqueous solution and 20 ppm of methylene blue, Cu²⁺, and Co²⁺, according to some embodiments. The different flux fouling trends showed that CMG can catalytically remove organic foulants from the membrane, contributed to a fouling resistant membrane surface, whereas such function was absent in the neat membrane. Sequentially, the J/J0 flux reductions rate of the neat and CMG membranes were investigated again with 20 ppm BSA, MB, Cu²⁺ and Co²⁺ in the feed solution and the results were presented in FIG. 10C and FIG. 10D.

The neat membrane showed an obvious flux decline at the earlier time and led to nearly 100% flux reduction rate, and the CMG membrane had a reduction rate of 42% only. Both indicated that the catalytic degradation effect played a vital role in removing the attached contaminant and prevented severe surface coverage and pore blocking by the foulant matter. The superior anti-fouling in both BSA only and with matrix of contaminants can be attributed to the generated ROS (OH, ·O₂⁻ and ¹O2) in the presences of MXene and H₂O₂.

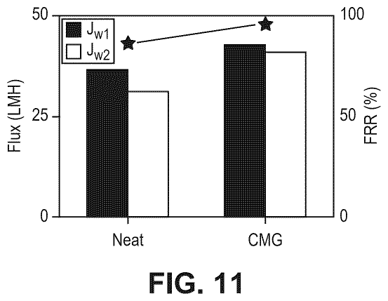

To analyze the fouling reversibility, the fouled membranes were chemically cleaned, and their DI water flux recovery rate (FRR) was calculated and plotted. FIG. 11 illustrates the flux and calculated flux recovery rate (FRR) for neat and CMG membranes, according to some embodiments. It is shown that the flux of the neat membrane decreased from 36.7 L m⁻² h⁻¹ to 31.4 L m⁻² h⁻¹ with a FRR value of 86% after cleaning. The BSA may have attached on the membrane surface and inside the membrane pore, making cleaning difficult and inevitably causing flux decline. In contrast, the after-cleaning flux of CMG membrane showed only a slight decrease from 42.8 L m⁻²h⁻¹ to 40.9 L m⁻²h⁻¹, achieving a high FRR value of 96%. This significant enhancement of cleaning performance can be contributed by the catalytic decomposition of foulant attached to the CMG membrane. The shows that the addition of H₂O₂ can promote the deep cleaning of membrane under the existence of MXene.

The fabricated nanocomposite membrane was developed by mixing the MXene and GO within chitosan polymer substrate. Benefiting from the abundant defect sites of MXene, the H₂O₂ was broken down catalytically to generate the reactive oxygen species. The electron paramagnetic resonance spectroscopy and fluorescence emission spectroscopy confirmed the formation of superoxide radicals (·O₂⁻) which were responsible for the effective removal of contaminants. SEM results demonstrated that plenty of laminar MXene prevailed inside the chitosan membrane, which served as the catalytic active sites and water transfer channel.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A membrane comprising:
a matrix material including chitosan;
graphene oxide dispersed in the matrix material; and
MXene material dispersed in the matrix material.

2. The membrane of claim 1, wherein the graphene oxide includes graphene oxide nanosheets.

3. The membrane of claim 1, wherein the MXene material includes a titanium-containing MXene.

4. The membrane of claim 3, wherein the titanium-containing MXene includes at least one of Ti₂CTₓ, Ti₃C₂Tₓ, and Ti₃CNTₓ.

5. The membrane of claim 1, wherein the membrane is a nanofiltration membrane sufficient for both separation and decomposition of one or more contaminants present in a fluid stream.

6. A method for removing one or more contaminants from a fluid stream comprising:
providing a membrane including a matrix material, graphene oxide dispersed in the matrix material, and MXene material dispersed in the matrix material; and
contacting a first fluid stream and the membrane sufficient to form a second fluid stream, wherein the first fluid stream includes one or more contaminants, and wherein the one or more contaminants include at least one of an organic compound and a metal ion.

7. The method of claim 6, wherein hydrogen peroxide is introduced to the membrane to generate one or more reactive oxygen species (ROS).

8. The method of claim 7, wherein the hydrogen peroxide is present in the first fluid stream.

9. The method of claim 7, wherein the one or more reactive oxygen species (ROS) are formed without use of ultraviolet irradiation.

10. The method of claim 6, wherein the one or more contaminants include the organic compound, and the organic compound includes an organic dye.

11. The method of claim 10, wherein the organic dye includes methylene blue.

12. The method of claim 6, wherein the one or more contaminants include the metal ion, wherein the metal ion includes at least one of a copper ion and a cobalt ion.

13. The method of claim 6, wherein the membrane is a nanofiltration membrane.

14. The method of claim 6, wherein the matrix material includes chitosan, and the MXene material includes a titanium-containing MXene.

15. A filtration apparatus comprising:
an inlet configured for introducing a first fluid stream;
a nanofiltration membrane in fluid communication with the inlet and configured to at least partially filter the first fluid stream sufficient to form a second fluid stream, wherein the nanofiltration membrane includes a matrix material, graphene oxide dispersed in the matrix material, and a MXene material dispersed in the matrix material; and
an outlet in fluid communication with the nanofiltration membrane and configured to receive the second fluid stream.

16. The filtration apparatus of claim 15, wherein the inlet includes a first conduit, and the outlet includes a second conduit.

17. The filtration apparatus of claim 15, wherein the matrix material includes chitosan, and the MXene material includes a titanium-containing MXene.

18. The filtration apparatus of claim 15, wherein the first fluid stream includes liquid water, and the liquid water includes a plurality of metal ions dispersed in the liquid water.

19. The filtration apparatus of claim 18, wherein the plurality of metal ions includes at least one of copper (Cu²⁺) ions and cobalt (Co²⁺) ions.

20. The filtration apparatus of claim 15, wherein the first fluid stream includes liquid water, and the liquid water includes an organic dye dispersed in the liquid water.
